(19) United States
(12) Patent Application Publication
(10) Pub. No.: US 2003/0159924 A1
(43) Pub. Date: Aug. 28, 2003

(54) Pt/ au electrodes for the pumping out 02 and method of production thereof

(76) Inventors: Dieter Lehmann, Weissach (DE); Gudrun Oehler, Stuttgart (DE); Sabine Thiemann-Handler, Stuttgart (DE)

Correspondence Address: KENYON & KENYON, ONE BROADWAY, NEW YORK, NY, 10004, US

(21) Appl. No.: 10/312,487

(22) PCT Filed: Jun. 20, 2001
(86) PCT No.: PCT/DE01/02281

(30) Foreign Application Priority Data
Jun. 24, 2000 (DE) 10030939.9

(51) Int. Cl. C25B 11/04; H01S 4/00

(52) U.S. Cl. 204/293; 29/592.1

(57) ABSTRACT

To provide a Pt/Au electrode which is used to electrochemically pump O₂ out of an O₂-containing gas mixture selectively in the presence of other oxygen-containing gas constituents and to provide a simple method of producing such a Pt/Au electrode, a Pt/Au electrode for electrochemically pumping out O₂ is described, its surface being impregnated with at least one compound of an alkali metal, an alkaline earth metal or a rare earth metal. A method of producing such a Pt/Au electrode in particular is also described, where the Pt/Au electrode is brought in contact with a solution containing at least one compound of an alkali metal, an alkaline earth metal or a rare earth metal, and the excess solvent is removed.

### BACKGROUND INFORMATION

The present invention relates to Pt/Au electrodes for pumping out O₂ electrochemically and a method of producing such electrodes.

Pt/Au electrodes are used in sensors for determining NOₓ in exhaust gases, for example, as described in U.S. Pat. No. 5,672,811 and in European Patent Application 0 678 740 A1. A first selective pumping cell in the sensor is used for pumping out the O₂ contained in the exhaust gas. The pumping current is regulated so that a certain voltage is obtained at the downstream potentiometric measurement cell relative to an air reference. O₂ should be pumped out as completely as possible without at the same time reducing any NOₓ present, so that the actual (NOₓ) measurement signal is not corrupted, this signal being determined by a second pumping cell. To ensure selectivity, Pt/Au electrodes having defined Au contents are used. However, adding Au to Pt electrodes results in “poisoning” of the electrode, i.e., resulting in lower O₂ pumping currents than is the case with a Pt electrode without Au. What this means for operation of the sensor is that O₂ might not be pumped out completely in the first pumping cell and thus the NOₓ signal is composed of the actual NOₓ reduction current and the residual O₂ current.

Advantages of the Invention

The object of the present invention is to provide a Pt/Au electrode which may be used to electrochemically pump out O₂ selectively from a gas mixture containing O₂ in the presence of other oxygen-containing gas constituents, and to provide a simple method of producing such a Pt/Au electrode.

This object is achieved with a Pt/Au electrode of the type specified in the preamble having the features of the characterizing part of claim 1 and with a method of the type defined in the preamble having the features of the characterizing part of claim 10.

The simple-to-perform impregnation of the electrode surface has a double effect. It evidently reverses the loss of O₂ pumping performance caused by the addition of Au without diminishing the effect of adding Au, which is to ensure the selectivity of pumping out O₂ in the presence of other oxygen-containing gas constituents such as NOₓ.

It is advantageous if the surface is impregnated with at least one compound of a rare earth metal (SE), even more advantageous if it is impregnated with a compound of a SE metal from the group Y, La, Pr, Gd and Dy and most especially advantageous if it is impregnated with a compound of Pr.

It is advantageous if the Pt/Au electrode is a cermet electrode, and it is even more advantageous if the ceramic part is made of ZrO₂, in particular Y-stabilized ZrO₂.

In an advantageous manner, the Pt/Au electrode according to the present invention is installed in the pumping cell for pumping out O₂, belonging to a sensor for determining gaseous oxidation products in a gas mixture containing O₂. It is advantageous if the solution contains the compound in an amount on the order of 2.5 wt %.

In an advantageous manner, the method according to the present invention is implemented in such a way that when Pt/Au electrodes are applied to the freely accessible surfaces of a substrate, the substrate together with the Pt/Au electrodes is immersed in the solution, then removed from the solution and dried, or if the Pt/Au electrode is part of the aforementioned sensor, the Pt/Au electrode is vacuum impregnated and then dried by heating.

Other advantageous embodiments of the Pt/Au electrode according to the present invention and the method according to the present invention for producing them are characterized in the subclaims.

### Drawing

The present invention is described in detail below on the basis of exemplary embodiments illustrated by the drawings, namely:

FIG. 1 shows a schematic cross-sectional diagram of a system to illustrate the present invention,

FIG. 2 shows a diagram illustrating the dependence of the O₂ pumping current on the type of SE ion used for impregnation according to the present invention,

FIG. 3 shows a schematic cross-sectional diagram of a detail of an NOₓ dual-chamber sensor, showing the first pumping cell equipped with electrodes according to the present invention, and

FIG. 4 shows a diagram illustrating the O₂ pumping current plotted against the concentration of O₂ in the exhaust gas in the case of impregnation with a Pr compound.

The present invention is described below primarily on the example of Pt/Au electrodes impregnated with SE compounds and the method of producing same. However, it should be pointed out here that although the present invention may be used to particular advantage with Pt/Au electrodes impregnated with SE compounds, and it is explained on the basis of such electrodes in particular, a variety of deviations from this example are possible within the scope of the claims.

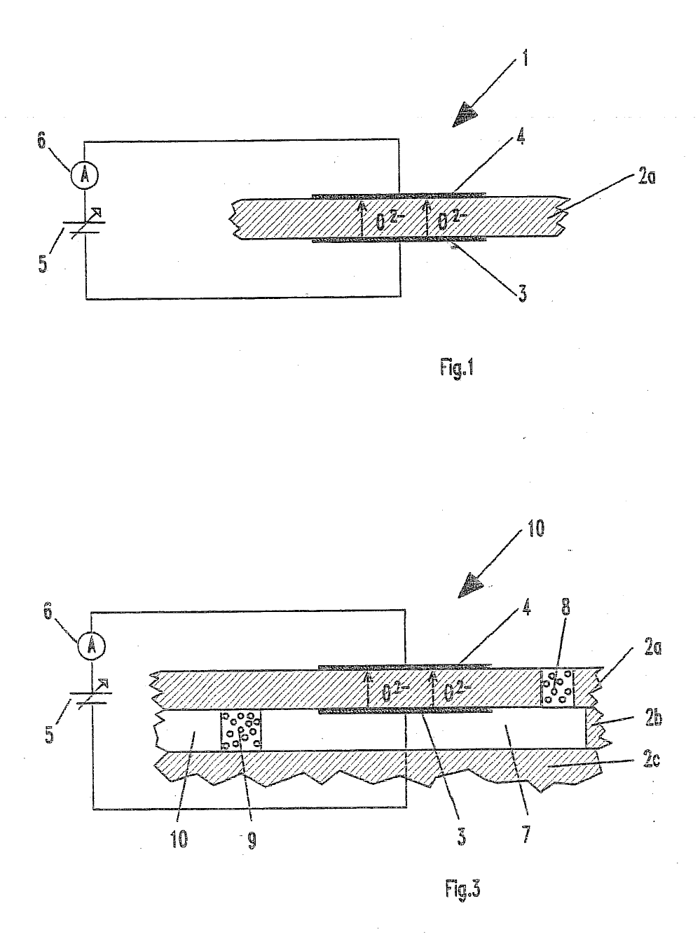

Device 1 shown in FIG. 1 contains a substrate 2a of a highly gastight solid electrolyte material such as ZrO₂ which has an oxygen ion conductivity and on whose two surfaces are applied Pt electrodes 3 and 4 having a defined Au content and facing one another. These are preferably cermet electrodes, for example, having Y-stabilized ZRO₂ as a component of the ceramic. The two electrodes are electrically connected to a voltage source 5.

If a gas mixture containing O₂ flows around substrate 2a, which is heated to a temperature on the order of at least 600° C. by a heater (not shown) and if a direct voltage is applied to the electrodes (electrode 3 being the cathode), then an O₂₋ current (O₂ pumping current) flows from electrode 3 to electrode 4 and is detected with measurement device 6.

When using conventional, unimpregnated Pt/Au electrodes, the O₂ pumping current depends on the Au content of the electrodes at a defined voltage U (typical Au contents are between approx. 0.5 and approx. 5 wt %, based on the metal content).

The present inventors have found that the influence of Au, which reduces the O₂ pumping current, may itself be decreased significantly if electrodes 3 and 4 are impregnated with at least one SE compound according to the present invention. As an alternative, the electrodes may also be impregnated with alkali metal compounds or alkaline earth metal compounds or with mixtures of at least two of these compounds.

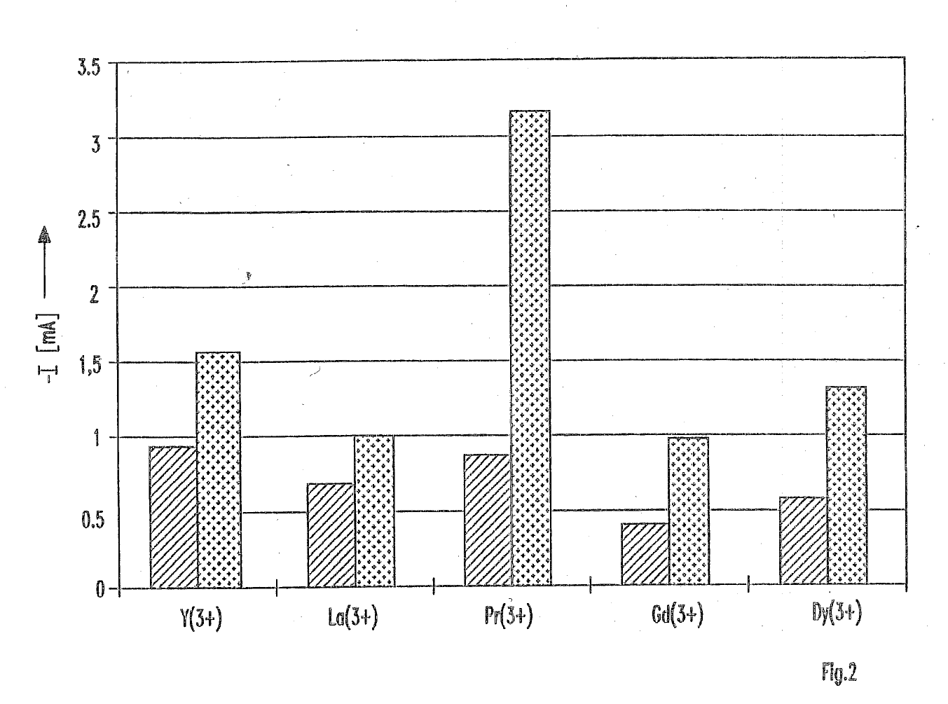

In the diagram according to FIG. 2, which is also based on measured values obtained using arrangement 1, the O₂ pumping current is plotted for a defined applied voltage in passing a measurement gas containing N₂ and 500 ppm O₂ past the electrodes before (hatched bars) and after (dotted bars) the impregnation according to the present invention of the electrodes (containing 1 wt % Au) with compounds of different SE. This diagram shows that the best results are obtained with Pr compounds.

The electrodes according to the present invention may be used to advantage, e.g., in the sensor known from the aforementioned European patent application and the aforementioned U.S. patent for determining NOₓ. FIG. 3 shows a detail of known sensor 10, which is, however, equipped with electrodes 3 and 4 according to the present invention. Sensor 10 has a plurality of laminated layers 2a through 2c of highly gastight solid electrolyte material such as ZrO₂ having an oxide ion conductivity. A recess in layer 2b forms a shallow chamber 7 which is connected to the exhaust gas through a gas passage 8 (made of porous Al₂O₃/ZrO₂, for example), which determines the diffusion, in layer 2a. Chamber 7 is connected by another diffusion-determining gas passage 9 to another chamber 10 formed by a recess in layer 2b. Chamber 7 contains at the surface of layer 2a a Pt/Au cermet electrode 3 impregnated according to the present invention, preferably containing Y-stabilized ZrO₂ as a ceramic component, corresponding to electrode 3 shown in FIG. 1 and facing a corresponding electrode 4 impregnated according to the present invention and applied to the opposite surface of layer 2a, this electrode 4 corresponding to electrode 4 shown in FIG. 1. The two electrodes are electrically connected to a voltage source 5 (according to the arrangement shown in FIG. 1). During use, a gas mixture which is to be analyzed flows through the tube in which the sensor is positioned. Part of the gas mixture is conveyed through gas passage 8 into chamber 7, flows past electrode 3 and through gas passage 9 into chamber 10 where the reduction of NOₓ takes place.

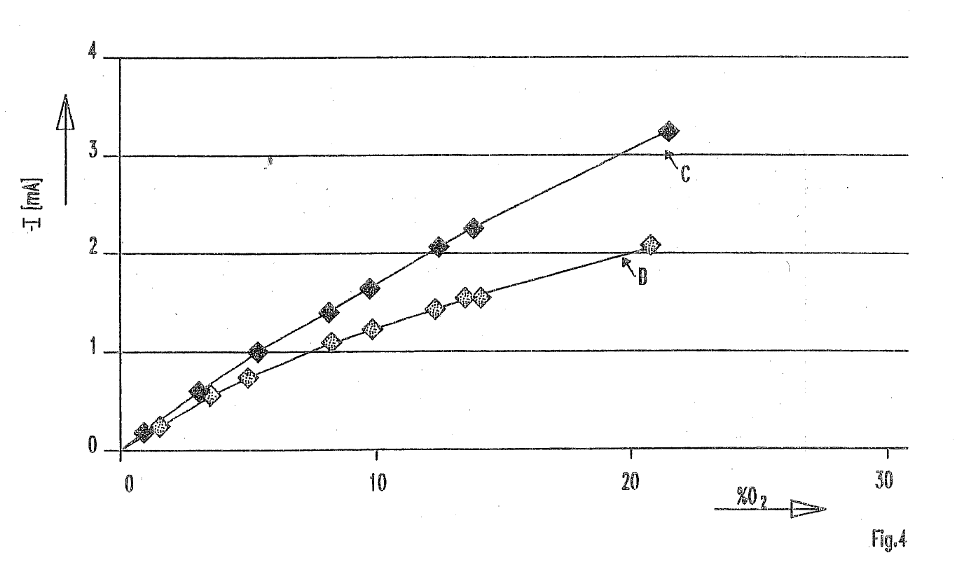

On the basis of current-concentration curves, the diagram in FIG. 4 shows the influence of impregnation with Pr ions [symbol] before impregnation, [symbol] after impregnation) of electrodes containing 1 wt % Au. These curves are based on measured values obtained using the sensor, a detail of which is shown in FIG. 3, through which measurement gases containing between 1 and 20 vol % O₂ flow. As these curves show, the linearity of the current-concentration curves is greatly improved by Pr impregnation. It has also been found that this impregnation does not impair the selectivity of reduction with respect to NOₓ.

To produce the electrodes according to the present invention which belong to a system like that illustrated in FIG. 1, substrate 2a, printed with the electrode material and sintered in the usual manner, is immersed in an approx. 0.1 to approx. 5 wt % preferably aqueous solution of the salt of a SE such as Pr(NO₃)₃ and then dried with gentle heat after removing it from the solution.

Production of the electrodes according to the present invention which are installed in a sensor, as illustrated in a detail in FIG. 3, is based on the known sensor produced according to the related art. This sensor is immersed in an approx. 2.5% preferably aqueous solution of a SE salt such as Pr(NO₃)₃, then vacuum impregnated, and finally the water in the interior of the sensor is evaporated while heating gently after removing it from the solution. As an alternative (see above), a solution of at least one alkali metal compound, a solution of at least one compound of an alkaline earth metal, or a solution containing at least two compounds from the groups of alkali metal compounds, alkaline earth metal compounds, and SE compounds is used for the impregnation. The solution of a Pr compound is preferred.

What is claimed is:

1. A Pt/Au electrode for electrochemical pumping of O₂, wherein its surface is impregnated with at least one compound of an alkali metal, an alkaline earth metal or a rare earth metal (SE).

2. The Pt/Au electrode as recited in claim 1, wherein the surface is impregnated with a compound of an SE.

3. The Pt/Au electrode as recited in claim 2, wherein the SE is selected from the group of Y, La, Pr, Gd and Dy.

4. The Pt/Au electrode as recited in claim 3, wherein the SE is Pr.

5. The Pt/Au electrode as recited in one of claims 1 through 4, wherein the electrode is a Pt/Au cermet electrode.

6. The Pt/Au electrode as recited in claim 5, wherein the ceramic component is essentially made up of ZrO₂.

7. The Pt/Au electrode as recited in claim 6, wherein the ceramic component is essentially made up of Y-stabilized ZrO₂.

8. The Pt/Au electrode as recited in one of claims 1 through 7, wherein at least the electrode which functions as the cathode is impregnated.

9. The Pt/Au electrode as recited in one of claims 1 through 8, wherein the electrode is installed in a pumping cell for pumping out O₂, the cell belonging to a sensor for determining oxygen-containing gas constituents in an O₂-containing gas mixture.

10. A method of producing a Pt/Au electrode, in particular as recited in one of claims 1 through 9, wherein the electrode is brought in contact with a solution which contains at least one compound of an alkali metal, an alkaline earth metal or a rare earth metal (SE), and the excess solvent is removed.

11. The method as recited in claim 10, wherein the SE is selected from the group Y, La, Pr, Gd and Dy.

12. The method as recited in claim 11, wherein Pr is selected as the SE.

13. The method as recited in one of claims 10 through 12, wherein the solution contains on the order of 0.1 to 5 weight % of the compound.

14. The method as recited in one of claims 10 through 13, wherein, when the Pt/Au electrodes are applied to the freely accessible surfaces of a substrate, the substrate is immersed in the solution, removed from the solution and dried.

15. The method as recited in one of claims 10 through 13, wherein, if the Pt/Au electrode is a part of the named sensor, the sensor is immersed in the solution, then vacuum-impregnated and finally dried by heating.
